(19) United States
(12) Patent Application Publication
(10) Pub. No.: US 2022/0153479 A1
(43) Pub. Date: May 19, 2022

(54) CONSUMER PACKAGING WITH ZIP RELEASE

(71) Applicant: Kwame Appiah, Inglewood, CA (US)

(72) Inventor: Kwame Appiah, Inglewood, CA (US)

(21) Appl. No.: 17/097,951

(22) Filed: Nov. 13, 2020

(51) Int. Cl. B65D 35/28; B65D 35/02; B65D 6/24

(52) U.S. Cl. CPC B65D 35/28; B65D 2231/027; B65D 11/1866; B65D 35/02

(57) ABSTRACT

A modified consumer packaging for a viscous personal care product is disclosed that can be opened preferably along a longitudinal edge or circumferential section to bypass its traditional delivery port and allow a consumer to access and collect product that otherwise would be discarded. A first example of this concept is an otherwise conventional toothpaste tube that includes a pull tab to open the tube along a longitudinal edge. The pull tab and the longitudinal seam (which can include perforations or reduced thickness) can be covered with a protective tape or film, and accessed only when the tube is substantially evacuated. Once the pull tab is actuated, the tube opens and the interior of the tube is exposed to allow product to be removed that otherwise would be inaccessible.

### BACKGROUND

The present invention relates generally to consumer packaging, and more particularly to consumer packaging that includes a zip release that allows access to the packaging's interior to allow inaccessible and unused product to be extracted from the packaging.

There are many examples of consumer packaging where it is accepted that all of the material in the packaging cannot be used. Toothpaste, for example, comes in tubes where the tube only allows about 90-95% of the toothpaste to be extracted before the tube is discarded. This unused toothpaste is product that the consumer has paid for but is not used due to the limitations of the packaging. With each purchase, the consumer pays for one hundred percent of the product but only enjoys ninety to ninety-five percent of the product for which he or she has paid. This happens with almost all viscous products, such as lotions, shampoos, pastes, gels, soaps, and the like. Both suppliers and customers acknowledge this problem, but toothpaste continues to be sold in tubes, lotion bottles continue to prevent access to the interior space, and soap dispensers continue to be sold so that not all of the product can be used by the patron.

The present invention addresses this problem by fabricating the consumer packaging so that a zip release allows the consumer to open the packaging when the contents are almost exhausted, exposing the interior of the packaging and allowing the last five to ten percent of the product to be accessed and acquired.

### SUMMARY OF THE INVENTION

The present invention is a modified consumer packaging for a viscous personal care product that can be opened preferably along a longitudinal edge or circumferential section to bypass its traditional delivery port and allow a consumer to access and collect product that otherwise would be discarded. A first example of this concept is an otherwise conventional toothpaste tube that includes a pull tab to open the tube along a longitudinal edge. The pull tab and the longitudinal seam (which can include perforations or reduced thickness) can be covered with a protective tape or film, and accessed only when the tube is substantially evacuated. Removing the protective tape or film, the pull tab can be activated to separate the adjoined edges of the tube along a longitudinal strip or seam. Once separated, toothpaste that remained in the crannies and nooks of the tube can be accessed by the consumer, resulting in many additional uses before the tube is fully exhausted. This saves the consumer money, saves the environment from unnecessary packaging waste, and benefits suppliers with greater customer satisfaction. The concept can be expanded to bottles of lotion, shampoo, soaps, etc., allowing consumers better value for their purchases. These and other features of the present invention will best be understood with reference to the detailed description of the invention below, along with the accompanying Figures.

### BRIEF DESCRIPTION OF THE DRAWINGS

FIG. 1 is a front view of a first preferred embodiment of the present invention;

FIG. 2 is a side view of the embodiment of FIG. 1;

FIG. 3 is a top view of the embodiment of FIG. 1;

FIG. 4 is a front view of the embodiment of FIG. 1 with the pull tab partially activated;

FIG. 5 is a front view of the embodiment of FIG. 1 with the pull tab entirely activated;

FIG. 6 is a front view of a second embodiment of the present invention;

FIG. 7 is a sectioned view of the embodiment of FIG. 6 with the pull tab activated; and

FIG. 8 is a cross section of the embodiment of FIG. 6.

### DETAILED DESCRIPTION OF THE PREFERRED EMBODIMENTS

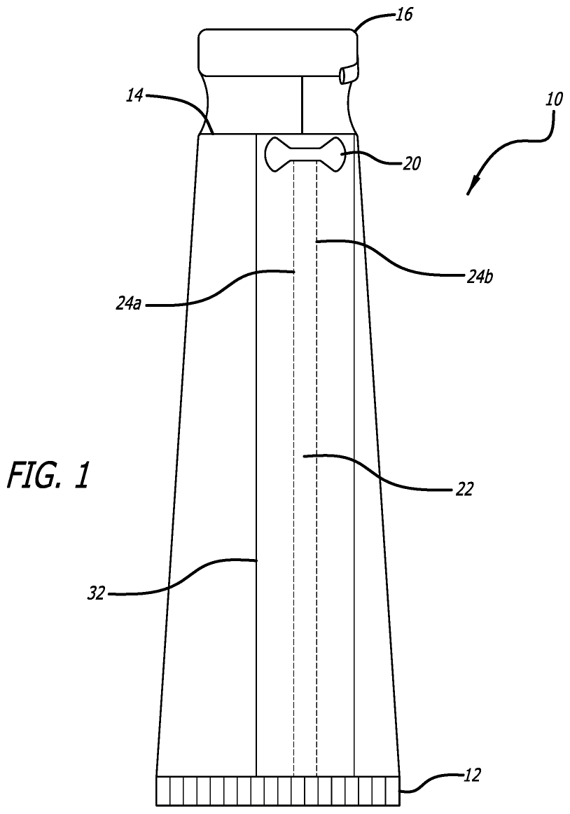

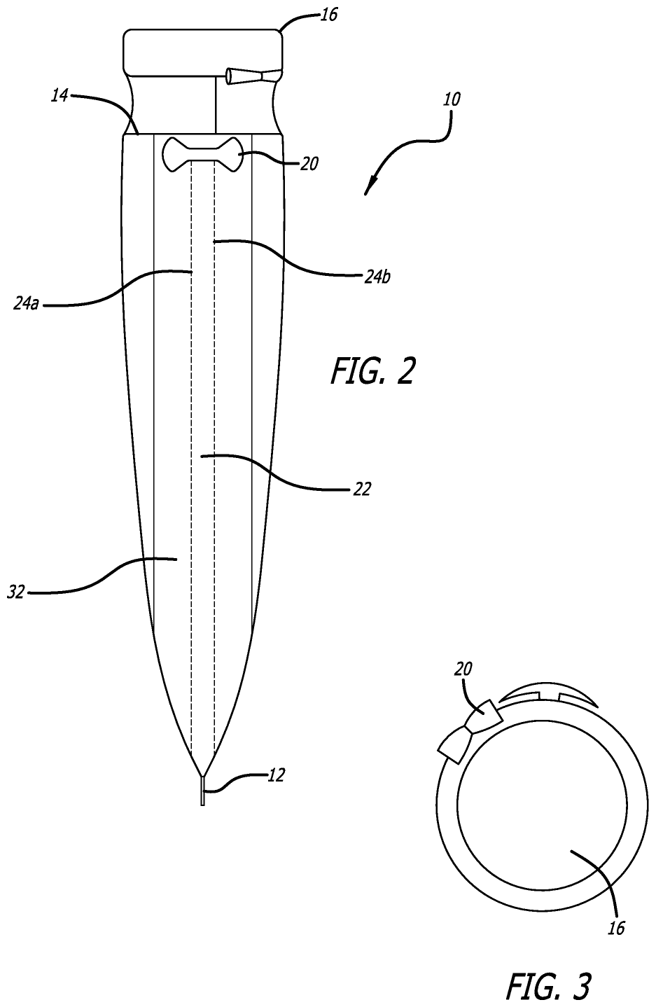

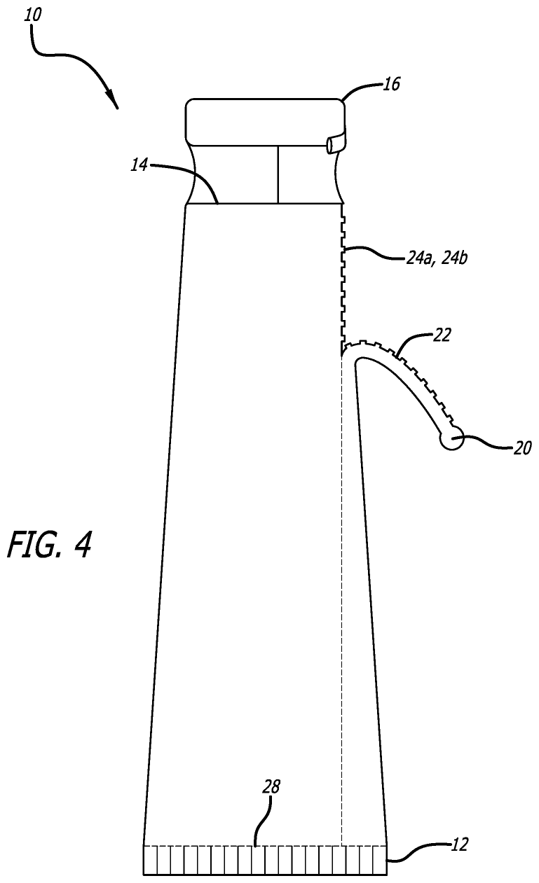

FIG. 1 illustrates a first embodiment of the present invention in the form of a toothpaste tube 10 having a flat seam 12 at a bottom edge and a circular end 14 at the opposite end. The tube has a reclosable cap 16 that encloses a spout (not shown) as is conventional in the art. Such tubes are typically fabricated from sheets of plastic laminate covering a layer of aluminum and pressed together. In a traditional toothpaste tube, the outer surface is continuous between the flat seam 12 and the circular end 14, and the volume defined by this surface is the repository for the product, i.e., the toothpaste. As the tube 10 is repeatedly squeezed, compressed, or rolled, toothpaste inside the tube is forced out through the spout until the tube is substantially empty. However, the repeated squeezing of the tube creates pockets, crevasses, and crannies where toothpaste gets trapped and is not available even with greater force.

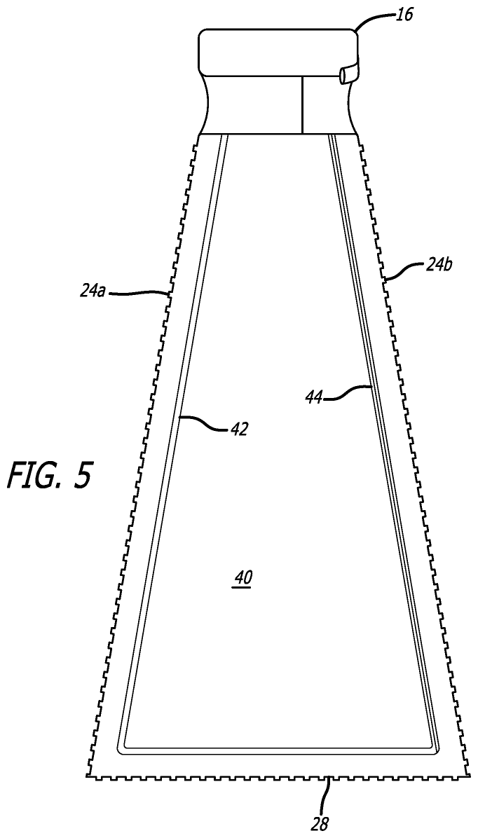

The present invention modifies the traditional tube by including a way to access the tube's interior in the form of a zip tie device. The zip tie device includes a pull tab 20 that is connected to a thin strip 22 defined by perforations 24a, 24b (or weakened material) along a longitudinal side of the tube 10. The thin strip 22 can be covered by a protective tape 32 film, or other covering that can be removed by the user prior to activating the pull tab 20. After the tube 10 has been substantially depleted of its contents by squeezing, the user removes the tape 32 and pulls the pull tab 20 down the length of the longitudinal side of the tube and across the bottom edge, causing the thin strip 22 to separate from the tube along the perforations 24a, 24b. The thin strip 22 can continue along a lower edge of the tube along perforation 28 to allow the tube to open along this newly formed slit down the tube and across the bottom edge. The pull tab 20 preferably opens the seam formed by the removal of the strip 22 all the way to the flat seam 12 of the tube, and preferably along the perforation 28 as well. FIG. 5 illustrates the tube splayed flat after removing the strip 22, forming a triangular shape that exposes all of the remaining toothpaste in the tube 10. As shown in FIG. 5, a zip lock type seal is provided on the tube's interior surface 40 comprising a male side 44 and a female side 42 that can be mated to create an airtight seal once the tube is opened along the perforations. This allows the consumer to continue to use the product each day without the product drying out due to the exposure after the tube has been opened.

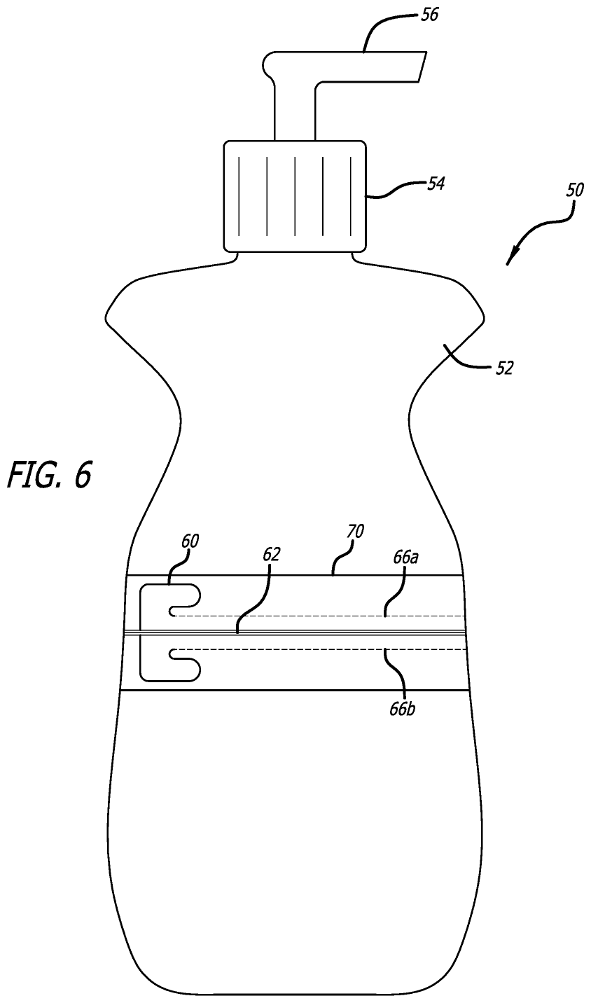

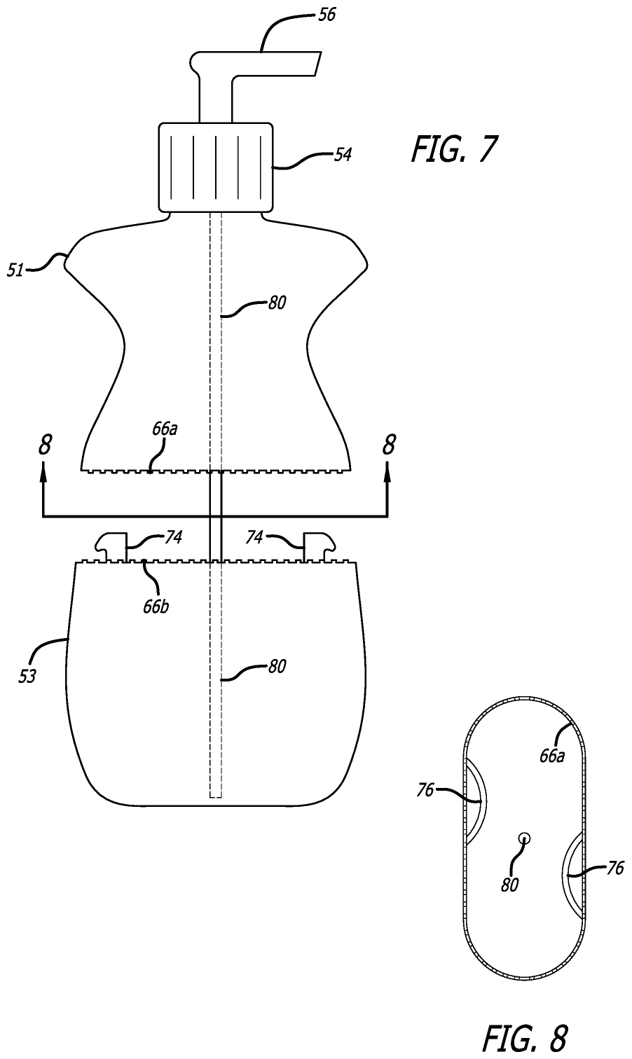

The concept can be applied to other personal product packaging such as lotion bottles, as shown in FIG. 6. Lotion bottle 50 is a conventional lotion bottle with a general circumferentially-shaped body 52, a cap 54, and a pump spout 56 that is connected to a tube 80 that extends to the bottom of the bottle 50 within its interior space. As the lotion in bottle 50 is used up, the pump at one point will no longer expel lotion, even though lotion is attached to the walls and at the bottom of the bottle. To overcome this problem, a zip tie solution is presented wherein a pull tab 60 is provided along a medial region of the bottle 50 that is connected to a circumferential strip 62 defined by upper and lower perforations 66a, 66b, respectively. As with the toothpaste tube, the pull tab 60 and perforations 66a, 66b may be covered with a protective film or tape 70 that preserves the integrity of the bottle until it is ready to be separated by the consumer. Once the bottle 52 no longer pumps lotion, the tape 70 is removed and the pull tab 60 is activated to remove the strip 62 at the two perforations. Once the strip 62 is removed, the bottle can be separated into an upper half 51 and a lower half 53, as shown in FIG. 7. This allows the consumer to access the bottle's interior and extract lotion that is adhered to the walls and pooled at the bottom of the bottle. In a preferred embodiment, the bottle 50 can be provided with resilient tabs 74 on one half of the bottle 50 that engage recesses 76 aligned vertically and spaced from the tabs 74 on the opposite half, as shown in FIG. 8.

Although two embodiments of the present invention have been illustrated and described, the concept can be easily extended to other personal care packaging where viscous materials are enclosed in packaging that does not readily allow access to the interior of the container. Thus, the invention should not be deemed to cover only these embodiments, but rather the invention is intended to cover a variety of packaging in shapes and sizes other than that depicted in the drawings.

I claim:

1. A toothpaste tube having a resealable spout, a flat seam at a first end and a circular second end connected to the resealable spout, the tube further comprising:
a pull tab connected to a longitudinal strip extending down the tube's length and defined by first and second longitudinal perforations extending from the pull tab to the first end; and
a protective, removable tape covering the pull tab and the longitudinal strip.

2. The toothpaste tube of claim 1, further comprising a transverse perforation extending from the first and second perforations, at the flat seam.

3. The toothpaste tube of claim 2, further comprising an airtight zip lock seal extending adjacent to the longitudinal and transverse perforations to allow the tube to be closed using the airtight zip lock seal.

4. The toothpaste tube of claim 3, wherein the airtight zip lock seal comprises a male half and a female half that interlock to create the airtight seal.

5. A plastic bottle comprising a cylindrical body, a resealable cap, and a pump spout attached to a tubular member extending to a bottom of the bottle's interior, the plastic bottle further comprising;
a pull tab connected to a circumferential strip extending around the bottle, the circumferential strip defined by first and second circumferential perforations extending from the pull tab;
a protective, removable tape covering the pull tab and the circumferential strip;
first and second resilient tabs extending from an interior surface of a first half of the bottle across the first and second perforations to complimentary first and second recesses on a second half of the bottle to releasably secure the bottle closed.
